(19) United States
(12) Patent Application Publication
(10) Pub. No.: US 2019/0164104 A1
(43) Pub. Date: May 30, 2019

(54) METHOD AND SYSTEM FOR QUALITY CONTROL OF A FACILITY BASED ON FEEDBACK FROM MULTIPLE SOURCES

(71) Applicant: Ruptub Solutions Private Limited, Karnataka (IN)

(72) Inventors: Sidharth Gupta, Bangalore (IN); Kadam Jeet Jain, Bangalore (IN); Rahul Chaudhary, Bangalore (IN); Punit Garg, Bangalore (IN); Khilan Haria, Bangalore (IN); Ankita Gandhi, Agra (IN); Vidit Sinha, Bangalore (IN); Rajdeep Singh, Karnataka (IN); Abhishek Nair, Mumbai (IN); Shashank Rao, Bangalore (IN); Shubhangi Agarwal, Lucknow (IN); Abhishek Malani, Hyderabad (IN); Raghavendra Reddy, ANDHRA PRADESH (IN); Ribin Paikattu Kavil, Bangalore (IN); Rahul Boggaram Nagarjuna Gupta, Bangalore (IN)

(21) Appl. No.: 15/897,332

(22) Filed: Feb. 15, 2018

(30) Foreign Application Priority Data
Nov. 25, 2017 (IN) 201741042319

(51) Int. Cl. G06Q 10/06; G06Q 50/12

(52) U.S. Cl. CPC G06Q 10/06395; G06Q 50/12

(57) ABSTRACT

A system for quality control of a facility based on feedback from multiple sources. The system receives data of the facility from plurality of data sources. The system creates one or more digital replica of the facility and classifies each region of the plurality of regions into plurality of checkpoint levels. The system assigns a plurality of micro-descriptors to the last level of the plurality of checkpoint levels and collects a feedback for the plurality of micro-descriptors from plurality of sources. The system collects data associated with the facility including facility-specific matrix and manpower specific matrix. The system maps the facility specific matrix with pre-defined quality specific matrix and evaluates deviation of the mapped data to identify one or more issues associated with the facility. The system assigns degree of severity to the identified issue and alerts if degree of severity is high.

### CROSS-REFERENCES TO RELATED APPLICATION

The present application claims the benefit under 35 U.S.C. § 119(e) of the filing date of India Patent Application Serial No. 201741042319 for SYSTEM FOR QUALITY CONTROL OF A FACILITY BASED ON FEEDBACK FROM MULTIPLE SOURCES, filed 25 Nov. 2017, which is hereby incorporated by reference in its entirety for all purposes.

### TECHNICAL FIELD

The present disclosure relates to a field of quality control management. More specifically, the present disclosure relates to a system for quality control of a facility based on feedback from multiple sources.

### BACKGROUND

Service industry has taken a major leap with the huge increase in number of people constantly travelling from one place to another. People are in constant need for a place to stay overnight or for a few days. Typically, people stay in various hotels which match their needs and comfort ability factor. These hotels have been operating in an automated fashion since very long. Nowadays, there are innumerable software systems for managing hotel operations in real time. Further, these hotels continuously try to evolve and understand their customer needs in order to be more efficient. Typically, these hotels regularly conduct customer satisfaction surveys in order to receive feedback from the customers. The feedback helps in determining the satisfaction level of the customers and whether they are content with the hotel facilities or not. The feedback from the visitors helps the hotel personnel to make necessary changes in hotel amenities to meet customer expectations. The feedback provided by the customer is used to make changes which are applied after the visitor has left the facility. In addition, a daily audit done by a quality manager for each room to identify issues and to keep a check on the issue being resolved before the room is allocated to any visitor is a long process. Further, the customer having any issue has to reach out to the front desk for resolving the issue which affects the customer's experience. The currently available systems do not allow the hotel staff to keep a check on the hotel facilities at a micro level.

### SUMMARY

In a first example, a computer-implemented method is provided. The computer-implemented method performs quality control of a digital facility based on feedback from a plurality of sources. The computer-implemented method may include a first step of receiving the first set of data associated with each region of a plurality of regions of the digital facility. In addition, the computer-implemented method may include a second step of creating one or more digital replica for each region of the plurality of regions associated with the digital facility. Further, the computer-implemented method may include a third step of classifying each region of the plurality of regions associated with the one or more digital replica into a plurality of checkpoint levels. Furthermore, the computer-implemented method may include a fourth step of assigning a plurality of micro-descriptors. The plurality of micro-descriptors may be assigned to lowest level of the plurality of checkpoint levels. Moreover, the computer-implemented method may include a fifth step of collecting a second set of data associated with the digital facility. Also, the computer-implemented method may include a sixth step of mapping the second set of data with a pre-defined quality specific matrix in real time. Also, the computer-implemented method may include a seventh step of evaluating a deviation of the mapped data in real time. Also, the computer-implemented method may include an eighth step of assigning a degree of severity to the identified one or more issues. The first set of data may be received from a plurality of data sources. The first set of data is received in real time. The one or more digital replica may be created with the facilitation of the first set of data. The plurality of checkpoint levels may be classified based on a pre-defined set of data. The plurality of micro-descriptors may be assigned to lowest level of the plurality of checkpoint levels. The plurality of micro-descriptors may facilitate to provide feedback of each region of the plurality of regions of the digital facility. The second set of data may be collected from the plurality of sources. The second set of data may include a facility-specific matrix of the digital facility. The facility-specific matrix may contain a plurality of quality specific data being collected in real time. The second set of data may include a manpower specific matrix of a plurality of manpower associated with the digital facility. The manpower specific matrix may contain a set of data of each of the plurality of manpower associated with the digital facility. The manpower specific matrix may be collected in real time. The evaluation may be done to identify the one or more issues associated with the digital facility. The assignment may be done to identify one or more high severity issues. The one or more high severity issues may be identified for rectification.

In an embodiment of the present disclosure, the plurality of data sources includes a facility manager, a digital camera, a digital blueprint, a communication device, and one or more graphical sensors.

In an embodiment of the present disclosure, the plurality of sources includes one or more visitor of the digital facility, one or more secret auditors, one or more feedback sensor, a one or more quality managers, the plurality of manpower associated with the digital facility and the digital camera.

In an embodiment of the present disclosure, the one or more issues includes fault in electrical appliance, unprofessional manpower, unprofessional quality manager, hygiene, cleanliness, security, limited amenities at the digital facility, wireless connectivity issues, noise, pollution and lack of manpower at the digital facility.

In an embodiment of the present disclosure, the method may include yet another step of updating of the first set of data, the second set of data, the one or more issues and the degree of severity. The updating is done in real time.

In an embodiment of the present disclosure, the method may include yet another step of storing of the first set of data, the second set of data, the one or more issues and the degree of severity. The storing is done in real time.

In an embodiment of the present disclosure, the method may include yet another step of allocating incentives to the plurality of manpower associated with the digital facility based on a plurality of factors.

In an embodiment of the present disclosure, the method may include yet another step of preventing the one or more issues and time to resolve the one or more issues in order to maintain the quality of the digital facility. The prediction being done based on the previously stored data and real-time data.

In an embodiment of the present disclosure, the method may include yet another step of predicting the one or more issues and time to resolve the one or more issues in order to maintain the quality of the digital facility. The prediction being done based on the previously stored data and real-time data.

In an embodiment of the present disclosure, the method may include yet another step of alerting the plurality of manpower associated with the digital facility to rectify the one or more issues prior to the time to resolve. The alerting is done in order to maintain quality of the plurality of regions of the digital facility. The alerting alerts the auditor to audit the plurality of regions of the digital facility.

In a second example, a computer system is provided. The computer system may include one or more processors and a memory coupled to the one or more processors. The memory may store instructions which, when executed by the one or more processors, may cause the one or more processors to perform a method. The method performs quality control of a digital facility based on feedback from a plurality of sources. The method may include a first step of receiving the first set of data associated with each region of a plurality of regions of the digital facility. In addition, the method may include a second step of creating one or more digital replica for each region of the plurality of regions associated with the digital facility. Further, the method may include a third step of classifying each region of the plurality of regions associated with the one or more digital replica into a plurality of checkpoint levels. Furthermore, the method may include a fourth step of assigning a plurality of micro-descriptors. The plurality of micro-descriptors may be assigned to lowest level of the plurality of checkpoint levels. Moreover, the method may include a fifth step of collecting a second set of data associated with the digital facility. Also, the method may include a sixth step of mapping the second set of data with a pre-defined quality specific matrix in real time. Also, the method may include a seventh step of evaluating a deviation of the mapped data in real time. Also, the method may include an eighth step of assigning a degree of severity to the identified one or more issues. The first set of data may be received from a plurality of data sources. The first set of data is received in real time. The one or more digital replica may be created with the facilitation of the first set of data. The plurality of checkpoint levels may be classified based on a pre-defined set of data. The plurality of micro-descriptors may be assigned to lowest level of the plurality of checkpoint levels. The plurality of micro-descriptors may facilitate to provide feedback of each region of the plurality of regions of the digital facility. The second set of data may be collected from the plurality of sources. The second set of data may include a facility-specific matrix of the digital facility. The facility-specific matrix may contain a plurality of quality specific data being collected in real time. The second set of data may include a manpower specific matrix of a plurality of manpower associated with the digital facility. The manpower specific matrix may contain a set of data of each of the plurality of manpower associated with the digital facility. The manpower specific matrix may be collected in real time. The evaluation may be done to identify the one or more issues associated with the digital facility. The assignment may be done to identify one or more high severity issues. The one or more high severity issues may be identified for rectification.

In a third example, a computer-readable storage medium is provided. The computer-readable storage medium encodes computer executable instructions that, when executed by at least one processor, performs a method. The method performs quality control of a digital facility based on feedback from a plurality of sources. The method may include a first step of receiving the first set of data associated with each region of a plurality of regions of the digital facility. In addition, the method may include a second step of creating one or more digital replica for each region of the plurality of regions associated with the digital facility. Further, the method may include a third step of classifying each region of the plurality of regions associated with the one or more digital replica into a plurality of checkpoint levels. Furthermore, the method may include a fourth step of assigning a plurality of micro-descriptors. The plurality of micro-descriptors may be assigned to lowest level of the plurality of checkpoint levels. Moreover, the method may include a fifth step of collecting a second set of data associated with the digital facility. Also, the method may include a sixth step of mapping the second set of data with a pre-defined quality specific matrix in real time. Also, the method may include a seventh step of evaluating a deviation of the mapped data in real time. Also, the method may include an eighth step of assigning a degree of severity to the identified one or more issues. The first set of data may be received from a plurality of data sources. The first set of data is received in real time. The one or more digital replica may be created with the facilitation of the first set of data. The plurality of checkpoint levels may be classified based on a pre-defined set of data. The plurality of micro-descriptors may be assigned to lowest level of the plurality of checkpoint levels. The plurality of micro-descriptors may facilitate to provide feedback of each region of the plurality of regions of the digital facility. The second set of data may be collected from the plurality of sources. The second set of data may include a facility-specific matrix of the digital facility. The facility-specific matrix may contain a plurality of quality specific data being collected in real time. The second set of data may include a manpower specific matrix of a plurality of manpower associated with the digital facility. The manpower specific matrix may contain a set of data of each of the plurality of manpower associated with the digital facility. The manpower specific matrix may be collected in real time. The evaluation may be done to identify the one or more issues associated with the digital facility. The assignment may be done to identify one or more high severity issues. The one or more high severity issues may be identified for rectification.

### BRIEF DESCRIPTION OF FIGURES

Having thus described the disclosed embodiments in general terms, reference will now be made to the accompanying drawings, which are not necessarily drawn to scale, and wherein:

FIG. 1A illustrates an example of plurality of regions of a digital facility, in accordance with an embodiment of the present disclosure;

FIG. 1B illustrates an example a room of a plurality of rooms of the digital facility, in accordance with an embodiment of the present disclosure;

FIG. 1C illustrates an example of plurality of checkpoints of each region of the plurality of regions of the digital facility, in accordance with an embodiment of the present disclosure;

FIG. 2 illustrates an interactive computing environment for processing of feedback collected from plurality of sources to check quality of the digital facility, in accordance with various embodiments of the present disclosure;

FIG. 3A and FIG. 3B illustrate a flowchart for a method for quality control of a digital facility based on feedback from a plurality of sources, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the present disclosure, and the present disclosure should not be construed as limited to the embodiments described. This present disclosure may be embodied in different forms without departing from the scope and spirit of the present disclosure. It should be understood that the accompanying figures are intended and provided to illustrate embodiments of the present disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

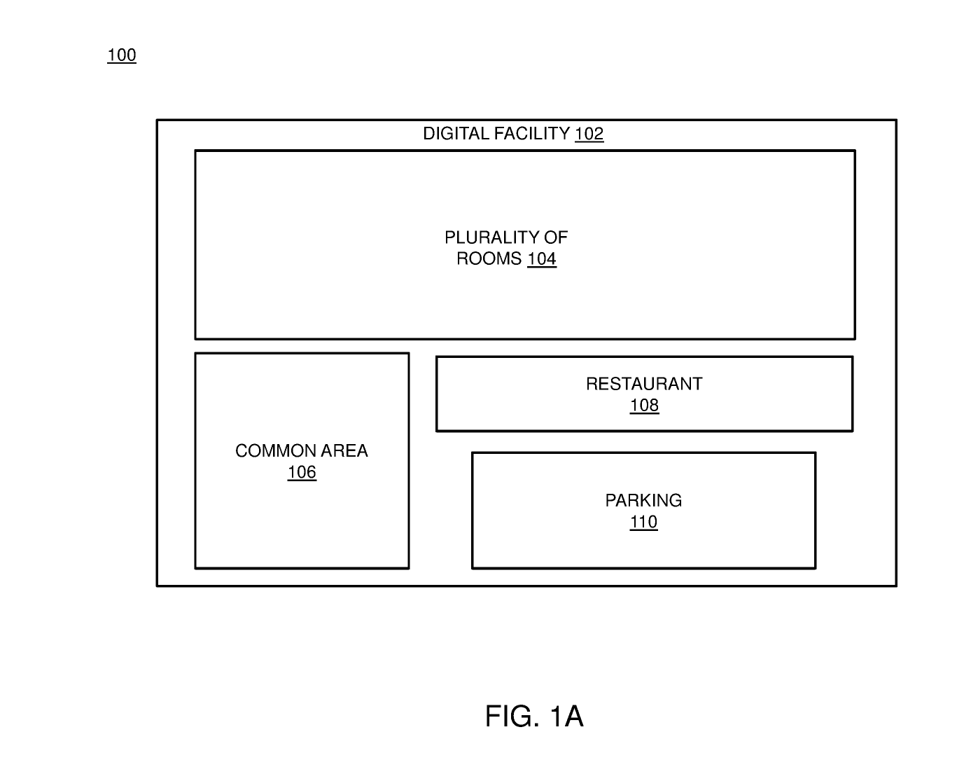

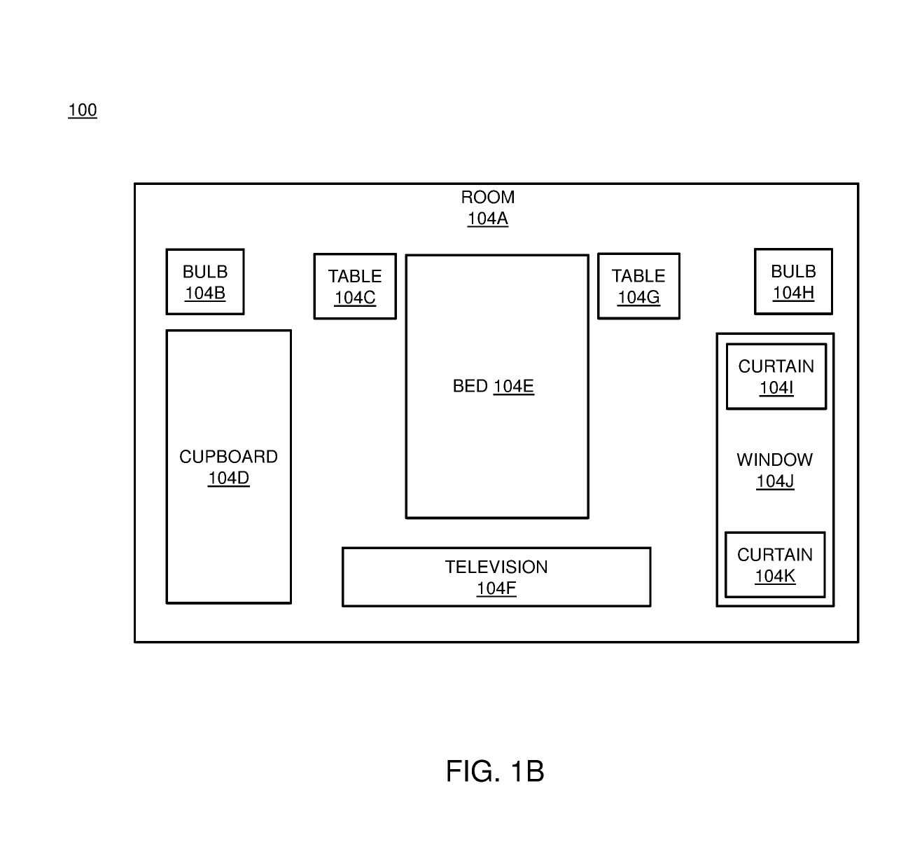

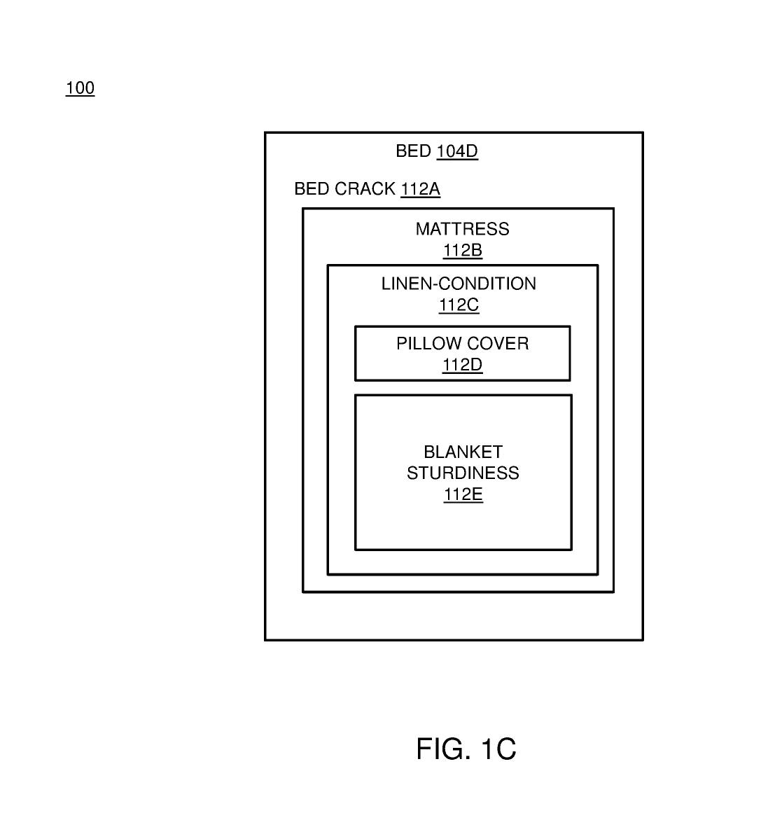

FIG. 1A illustrates a block diagram 100 of a digital facility 102 in accordance with various embodiments of the present disclosure. The digital facility 102 is a place where people live or stay for a period of time. The digital facility 102 may be a hotel which provides accommodation, meals, and hospitality services for the visitors on a short-term basis and provides space for conducting conference, meetings, social gathering, family function, events, and the like. In an embodiment of the present disclosure, the digital facility 102 may be a hospital which provides health care services to the people. In another embodiment of the present disclosure, the digital facility 102 may be a house or a school. In another embodiment of the present disclosure, the digital facility 102 may be the guest house which provides accommodation facility to the guest or visitor. In yet another embodiment of the present disclosure, the digital facility 102 may be a military base which is operated by or for the military. In yet another embodiment of the present disclosure, the digital facility 102 may be an old age home or place of work. In yet another embodiment of the present disclosure, the digital facility 102 may be a lodge, boarding house or a supermarket. In yet another embodiment of the present disclosure, the digital facility 102 includes but is not limited to production area of a factory or an industry. In yet another embodiment of the present disclosure, the digital facility 102 includes but is not limited to a mall, railway station, bus station and the like. The digital facility 102 includes a plurality of regions which are used to specify the area of the digital facility 102 in order to identify the regions for quality control.

In an embodiment of the present disclosure, the digital facility includes a plurality of regions. The plurality of regions includes but is not limited to a plurality of rooms 104, a common area 106, a restaurant 108, parking 110, kitchen, garden, reception area, corridor and stairs. In another embodiment of the present disclosure, the plurality of regions includes but is not limited to shopping area, cash counter, baggage counter, ticket counter, help desk, waiting area, toilets and conference area. In yet another embodiment of the present disclosure, the plurality of regions includes but is not limited to the meeting area, event area, the ground area, task area, gym area, swimming area, classroom area and canteen area. The plurality of rooms is area of the digital facility where people live. In an embodiment of the present disclosure, the plurality of rooms includes but is not limited to a hotel room, kids room, living room, meeting room, dining room, staff room, classroom, activity room, changing room and store room. The plurality of regions is further broken down into multiple region to specify the components of the plurality of regions.

In an example, as illustrated in FIG. 1A the plurality of regions of the digital facility 102 consists of the plurality of rooms 104, the common area 106, the restaurant 108, and the parking area 110.

FIG. 1B illustrates an example of a room 104a of the plurality of rooms 104 of the digital facility 102, in accordance with various embodiments of the present disclosure. Each region of the plurality of regions is further classified into various quality points. Each region of the plurality of regions is used to specify a particular area of a plurality of areas of the digital facility. Each region specifies area where a check on the quality should be maintained in the digital facility. Each region includes but is not limited to the bed area, table area, chair area, bulb area, curtain area, window area, almirah area, working area and fan area. In an embodiment of the present disclosure, each region of the plurality of regions includes but is not limited to the stage area, car parking area, bus parking area, ammunition area, tent area, shower area, towel area, soap area and carpet area. In another embodiment of the present disclosure, each region of the plurality of regions includes but is not limited to instrument area, book area, locker area, A.C area, pool area, spa area and the like.

In an example, as illustrated in FIG. 1B, each region of the plurality of regions of the digital facility has been specified by taking an example of the room 104a from the plurality of rooms 104 of the digital facility 102. Each region of the plurality of regions consists of Bulb 104b, table 104c, cupboard 104d, bed 104e, television 104f, another table 104g, another bulb 104h, curtain 104i, window 104j and curtain 104k. Each of the specified area defines each region of the plurality of regions.

FIG. 1C illustrates an example block diagram of a plurality of checkpoints of the digital facility 102, in accordance with various embodiments of the present disclosure. The example specifies quality points which need to be ensured for keeping the quality of each region of the plurality of regions of the digital facility 102. The quality points are used to specify the particular points of each region of the plurality of regions of the digital facility 102. Each quality point specifies the area where a check on quality should be maintained in the digital facility 102. The quality points include but is not limited to bed crack 112a, mattress 112b, linen-condition 112c, pillow cover 112d, blanket sturdiness 112e, bulb light, television light, adaptor, television wire and curtain rod. In an embodiment of the present disclosure, the quality point include but is not limited to the door, water cooler, box, chair cover, carpet, mirror, bathroom cabinet, laptop stand and iron stand. In another embodiment of the present disclosure, the quality points includes but is not limited to curtain, cupboard cover, cupboard lock, fan stand, fan, air conditioner, heater, table cover and chair cover. In yet another embodiment of the present disclosure, the quality point include but is not limited to soap dispenser, coffee machine, sturdiness, cleanliness, linen condition, shower, air freshener, exhaust, faucets, toilet paper and flush. In yet another embodiment of the present disclosure, the quality point include but is not limited to welcome drink, elevator, emergency light, fragrance, elevator, shafts, Wi-Fi signal, staff dress, wall, noise and upholstery.

In an example, as illustrated in FIG. 1C, the quality points of the bed 104e are specified to showcase the quality points that may be used for quality control for each region of the plurality of regions of the digital facility 102. The quality points of bed 104e are bed crack 112a, mattress 112b, linen-condition 112c, pillow cover 112d and blanket sturdiness 112e.

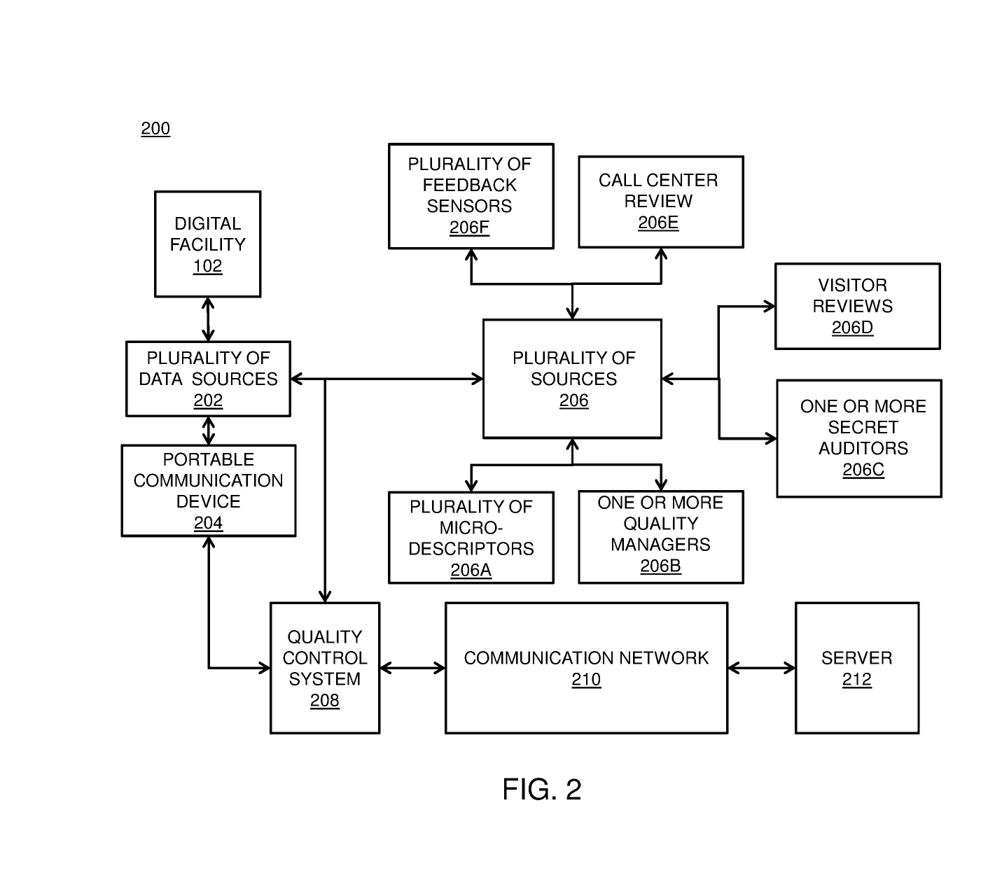

FIG. 2 illustrates a block diagram 200 of an interactive computing environment for processing of feedback collected from a plurality of sources 206 in real time to keep a check on the quality of the digital facility 102, in accordance with various embodiments of the present disclosure. It may be noted that to explain the system elements of FIG. 2, references will be made to the elements of FIG. 1A, FIG. 1B and FIG. 1C. The interactive computing environment includes a plurality of data sources 202 and a portable communication device 204. In addition, the interactive computing environment includes the plurality of sources 206, a plurality of micro descriptors 206a, one or more quality managers 206b, one or more secret auditors 206c, visitor reviews 206d, call center review 206e and a plurality of feedback sensors 206f. Further, the interactive computing environment includes the digital facility 102, a quality control system 208, a communication network 210 and a server 212. The plurality of data sources 202 is used to collect information of the digital facility 102. The plurality of data sources 202 includes a facility manager, a digital camera, a digital blueprint, a communication device, one or more graphical sensors and the like. In an embodiment of the present disclosure, the plurality of data sources 202 includes but is not limited to a visitor, facility staff, architectural view of the facility and the like. In yet another embodiment of the present disclosure, the plurality of data sources 202 includes but is not limited to data entered by the facility manager on the portable communication device 204. In another embodiment of the present disclosure, the plurality of data sources 202 includes but is not limited to Google map, 3D camera, biosensors and building information models.

In another embodiment of the present disclosure, the portable communication device 204 is any device which helps to communicate information. The portable communication device 204 includes but is not limited to a smartphone, a laptop, a desktop computer, a tablet and a personal digital assistant. In another embodiment of the present disclosure, the recording facility is enabled through one or more microphones installed in the portable communication device 204. In another embodiment of the present disclosure, the image capturing facility is enabled through one or more camera installed in the portable communication device 204. In an embodiment of the present disclosure, the portable communication device 204 is currently in the switched-on state.

Further, the interactive computing environment includes the plurality of sources 206 to gather information. The plurality of sources includes the plurality of micro-descriptors 206a, the one or more quality managers 206b, the one or more secret auditors 206c, visitor reviews 206d, call center reviews 206e, the plurality of feedback sensors 206f, and the like. In an embodiment of the present disclosure, the plurality of sources 206 additionally includes social media, survey, feedback boxes and feedback tab. The plurality of sources 206 is used to collect feedback in order to identify issues, check visitor satisfaction and maintain the quality of the digital facility 102. The feedback is information provided about the satisfaction or dissatisfaction regarding a service or a product. The feedback is given by the employee, visitor, any other person through the survey, feedback tab, feedback box, through the email and the like.

In an embodiment of the present disclosure, the plurality of micro-descriptors 206a is used to specify the responsibility area of the digital facility 102 in order to maintain quality and gather information regarding the quality of each region in real time. The plurality of the micro-descriptor 206a is used to specify each region of the plurality of regions where an issue is raised by the visitor or where there are chances of the issue being related to the quality of the digital facility 102. The plurality of micro-descriptors 206a is pre-defined in the quality control system and updated at any time. The plurality of micro-descriptors 206a includes but is not limited to bed crack, linen condition, mattress, bedsheet stain, pillow cover, blanket sturdiness, bulb light, television light, adaptor, television wire, curtain rod, curtain, and the like.

In an embodiment of the present disclosure, the plurality of micro-descriptors 206a includes but is not limited to table cover, chair cover, door, water cooler, heater, chair cover, carpet, mirror, bathroom cabinet, laptop stand and iron stand. In another embodiment of the present disclosure, the plurality of micro-descriptors 206a includes but is not limited to soap dispenser, coffee machine, sturdiness, cleanliness, linen condition, shower pressure, air freshener, exhaust, faucets and toilet paper. In yet another embodiment of the present disclosure, the plurality of micro-descriptors 206a includes but is not limited to welcome drink, elevator, emergency light, fragrance, elevator, shafts, Wi-Fi signal and staff dress. In yet another embodiment of the present disclosure, the plurality of micro-descriptors 206a includes but is not limited to CCTV working, walls, ambiance, buffet counter, hygiene, staff grooming, CCTV video quality, and the like. In yet another embodiment of the present disclosure, the plurality of micro-descriptors 206a includes mop, table dust, staff behavior, kettle, window pane, T.V wire, light switch, feedback tab, fire safety, smoke alarm, and the like. In yet another embodiment of the present disclosure, the plurality of micro-descriptors 206a includes a public washroom, flush, wall, noise, upholstery, cupboard cover, cupboard lock, fan stand, fan, air conditioner and the like.

In an embodiment of the present disclosure, the one or more quality managers 206b are persons who keep a check on the quality of the digital facility 102. The one or more quality managers 206b include a member of the digital facility 102 who is not associated as one or more staff of the digital facility 102, any person from the franchiser in case of the franchised digital facility and the like. The one or more quality managers 206b are assigned a task to audit each region of the plurality of regions of the digital facility 102 where there is issue or issue may be raised in the near future. The one or more quality managers 206b are assigned a task based on demographic information of the one or more quality managers 206b which is stored in the quality control system 208. The one or more quality managers 206b are notified by a notification on a portable communication device based on his demographic information and the task which he needs to perform in order to maintain the quality of the digital facility 102. The one or more quality managers 206b are to audit each region of the plurality of regions which are specified in the task and report the condition of one or more issues.

In an embodiment of the present disclosure, the demographic information includes data related to the plurality of manpower which comprises name, age, city, contact details, permanent address and the like. In another embodiment of the present disclosure, the demographic information includes alternative address, qualification, date of joining of the digital facility and the like. The demographic information includes but is not limited to gender, profession and name of the digital facility 102 assigned to the one or more quality managers 206b in case of data related to one or more quality managers 206b.

In an example, if the quality manager X is having plumbing as his profession in the demographic information stored in the quality control system and there is need to check quality of plumbing in the digital facility D. The quality manager X is assigned the task of auditing the plumbing of the digital facility D as the digital facility D is mentioned in the demographic information of the quality manager X.

In an embodiment of the present disclosure, the one or more issues are problems that may occur which will affect the quality of the digital facility 102. In an embodiment of the present disclosure, the one or more issues include fault in electrical appliance, unprofessional manpower, unprofessional quality manager, hygiene, and the like. In an embodiment of the present disclosure, the one or more issues include cleanliness, security, limited amenities at the digital facility, wireless connectivity issues, noise, pollution and the like. In an embodiment of the present disclosure, the one or more issues include lack of manpower at the digital facility, sturdiness, cleanliness, linen condition, toilet paper, and the like. In an embodiment of the present disclosure, the one or more issues include shower pressure, air freshener, exhaust, faucets, CCTV working, walls, ambiance, buffet counter, CCTV video quality and the like. In an embodiment of the present disclosure, the one or more issues include hygiene, table dust, staff behavior, kettle, window pane, T.V wire, light switch, feedback tab, fire safety, smoke alarm and the like.

In an embodiment of the present disclosure, the one or more secret auditors 206c are persons who are assigned the task of secretly conducting the quality check of the digital facility 102. The one or more secret auditors 206c are any person who is not the member of the digital facility 102, a visitor of the digital facility 102 and the like. A notification is sent based on the location of the digital facility to the one or more secret auditors 206c nearby the digital facility for audit. One of the secret auditors from the one or more secret auditors 206c accepts the request for auditing and assigned a checklist which needs to be checked in order inspect the quality of the digital facility 102. One of the secret auditors provides a personal feedback regarding the changes that need to be made in order to enhance the quality of the digital facility. In another embodiment of the present disclosure, the one or more secret auditors 206c select the hotel of his choice for audit based on his preferred location in order to inspect the quality of the digital facility. The one or more secret auditors 206c selects a city of his choice and enter the date of his stay based on which a list of the digital facility is shown to the one or more secret auditors 206c. The one or more secret auditors 206c selects the digital facility 102 from the list of the digital facility to book a room from the plurality of rooms 104 of the digital facility 102 based on the availability of the room from the plurality of the rooms. After the stay at the digital facility, the one or more secret auditors 206c provide his feedback on the quality of the digital facility 102.

In another embodiment of the present disclosure, the visitor reviews 206d is the review and rating provided by the visitor at the digital facility 102 on any social media platform, as a testimonial on the digital facility website, and the like. The visitor reviews 206d act as a basis for improvement of the quality of the digital facility 102. The visitor reviews 206d are collected at the digital facility by using the feedback tabs, survey and the like. In addition, the visitor reviews 206d include review about the staff, reviews about defects, reviews about overall experience at the digital facility 102 and the like. Furthermore, the visitor reviews 206d includes but is not limited to reviews about water pressure, reviews about table issue, reviews about staff dress, reviews about the reception, reviews about the event and reviews about the food. Moreover, the visitor reviews 206d includes reviews about ambiance, reviews about fragrance, reviews about drinking water, reviews about electricity, reviews about reviews about sound level, reviews about the elevator and the like. Also, the visitor reviews 206d includes but is not limited to reviews about the gym, reviews about the garden and reviews about the air conditioner.

In another embodiment of the present disclosure, the call center reviews 206e is a review provided by the call center which is collected by calling or by emailing visitors to provide review and rating. In addition, the call center reviews 206e includes but is not limited to review about the staff, reviews about defects, reviews about overall experience at the digital facility and reviews about the gym. Furthermore, the call center reviews 206e included reviews about the air conditioner, reviews about water pressure, reviews about table issue, reviews about staff dress, reviews about the reception, and the like. Moreover, the call center reviews 206e includes reviews about ambiance, reviews about fragrance, reviews about drinking water, reviews about electricity, and the like. Also, the call center reviews 206e includes reviews about sound level, reviews about the elevator, reviews about the garden, reviews about the event, reviews about the food, and the like.

In another embodiment of the present disclosure, the plurality of feedback sensors 206f is used to collect information of the plurality of micro-descriptors 206a. The plurality of feedback sensors 206f is based on internet of things, embedded sensors, and the like. The plurality of feedback sensors 206f includes temperatures sensor, pressure sensor, biosensor, an image sensor, motion sensor, level sensor, humidity sensor, tilt sensor, photoelectric sensor and the like. In addition, the plurality of feedback sensors 206f includes defect detector, speed flow sensor, fire sensor, smoke sensor, air sensor, position sensor, alarm sensor, odometer, pyrometer, an infrared sensor, stretch sensor, and the like.

Furthermore, the interactive computing environment includes the quality control system 208. The quality control system 208 performs the task of maintaining the quality of the digital facility 102 in real time. The quality control system 208 keep check on the quality by performing sequence of tasks which includes identification of the one or more issues, prediction of the one or more issues, assigning task to the plurality of auditor and the like. The quality control system 208 perform task which includes assigning incentives to the plurality of manpower associated with the digital facility and the like.

The quality control system 208 receives a first set of data in real time. The first set of data is associated with each region of the plurality of regions of the digital facility 102. The first set of data is received from the plurality of data sources 202. In an embodiment of the present disclosure, the first set of data includes the architectural information, interior information of the digital facility 102, images of the digital facility 102, 360-degree view of the digital facility 102 and the like. In an embodiment of the present disclosure, the architectural information includes building architecture, outside view of the digital facility, inside view of the digital facility 102 and the like. In another embodiment of the present disclosure, the architectural information includes number of floors of the digital facility 102, garden architectural information, parking architectural information and gym architectural information. In another embodiment of the present disclosure, the architectural information includes but is not limited to club architectural information, pool area, spa area, drinking area, concert area and the like.

In an embodiment of the present disclosure, the interior information includes room interior information, restaurant interior information, toilets interior information, library interior information and the like. In another embodiment of the present disclosure, the interior information includes spa interior information, office interior information, meeting room interior information and the like.

In an example, the first set of data includes building architecture, outside view of the facility, inside view of the facility, number of floors, placement of windows, placement of reception and the like.

In addition, the quality control system 208 creates one or more digital replica for each region of the plurality of regions of the digital facility 102 by using the first set of data in real time. In general, the digital replica is a reproduction or copy of the original, concerning original shape and appearance. In an embodiment of the present disclosure, the one or more digital replica includes but is not limited to a 3D view, 3D animation and architectural visualization.

Further, the quality control system 208 classifies each region of the plurality of regions associated with the digital facility 102 into a plurality of checkpoints levels. The plurality of checkpoints levels is used to simplify the distribution of each area of the plurality of areas of the digital facility 102. The plurality of checkpoint levels is used to simplify the user interface on the portable communication device 204 and provide ease of use. The plurality of checkpoint levels is defined from outside to the inside of each area of the plurality of areas of the digital facility such that each level holds the plurality of checkpoints. The lowest level of the plurality of checkpoint levels holds the plurality of checkpoints which defines the key areas of the plurality of areas of the digital facility to be considered for maintaining the quality of the digital facility. The lowest level of the plurality of levels is used to specify the plurality of checkpoints where an issue may be present or one which is essential for maintaining the quality of the digital facility 102. The plurality of checkpoints specified at the lowest level of the plurality of checkpoint levels is used to define the issue and time to resolve a particular issue. The plurality of checkpoint levels is classified based on a pre-defined set of data.

The pre-defined set of data is the key area for each area of the plurality of areas of the digital facility 102 considered for maintaining the quality. The pre-defined set of data is provided by the digital facility owner, visitor, one or more quality managers 206b, franchiser in case of a franchise, and the like which can be updated any time. In an embodiment of the present disclosure, the pre-defined set of data includes bed crack, linen condition, mattress, bedsheet stain, pillow cover, blanket sturdiness, bulb light, television light, adaptor and the like. In another embodiment of the present disclosure, the pre-defined set of data includes television wire, curtain rod, curtain, cupboard cover, cupboard lock, fan stand, fan, air conditioner and the like. In yet another embodiment of the present disclosure, the pre-defined set of data includes but is not limited to table cover, chair cover, door, water cooler, heater, chair cover, carpet, mirror, bathroom cabinet and the like. In yet another embodiment of the present disclosure, the pre-defined set of data includes a soap dispenser, coffee machine, sturdiness, cleanliness, linen condition, shower pressure and the like. In yet another embodiment of the present disclosure, the pre-defined set of data includes air freshener, exhaust, faucets, toilet paper, flush, wall, noise, upholstery and the like. In yet another embodiment of the present disclosure, the pre-defined set of data includes welcome drink, elevator, emergency light, fragrance, elevator, shafts, Wi-Fi signal, staff dress and the like. In yet another embodiment of the present disclosure, the pre-defined set of data includes staff behavior, kettle, window pane, TV wire, light switch, feedback tab, public washroom and the like. In yet another embodiment of the present disclosure, the pre-defined set of data includes buffet counter, hygiene, staff grooming, CCTV video quality, mop, dusting, vacuum cleaning, fire safety, smoke alarm and the like.

In an example, the digital facility 102 is a hotel X consisting of the plurality of rooms 104, the common area 106, the restaurant 108 and the parking 110. The first set of data is received by the quality control system which creates the one or more digital replica of the digital facility 102. The one or more digital replica is used to classify each area of the plurality of areas of the digital facility 102 into plurality of checkpoint levels, such that plurality of checkpoint levels helps to simplify the user interface and provide ease of use. The checkpoint level 1 holds the plurality of areas as shown in FIG. 1A, such as common area 106, the plurality of rooms 104, restaurant 108 and parking 110. In addition, checkpoint level 2 consist of each area of the plurality of areas as shown of FIG. 1B for rooms, such as bulb 104b, table 104c, cupboard 104d, bed 104e, television 104f, table 104g, bulb 104h, curtain 104i, window 104j and curtain 104k. The checkpoint level 3 holds the key area for maintaining the quality of the digital facility 102 as shown in FIG. 1C for bed, such as bed crack 112a, mattress 112b, linen-condition 112c, pillow cover 112d and blanket sturdiness 112e. The checkpoint level 4 holds the details of the condition that may occur to the key area, for linen condition it would be Soft Stains, Hard Stains, Worn out and the like.

Further, the quality control system 208 assigns the plurality of micro-descriptors 206a which facilitates to provide feedback of each region of the plurality of regions of the digital facility 102. The plurality of micro-descriptors 206a is assigned to the lowest level of the plurality of checkpoint levels of the digital facility 102. The feedback is collected for the plurality of micro-descriptors 206a. The plurality of micro-descriptors 206a is used to specify the responsibility area of the digital facility 102 in order to maintain quality and collect information regarding the quality of each region in real time.

Furthermore, the quality control system 208 collects a second set of data associated with the digital facility 102 in real time. The second set of data is collected from the plurality of sources 206 for the plurality of micro-descriptors 206a. In an embodiment of the present disclosure, the second set of data includes but is not limited to a facility-specific matrix of the digital facility, a manpower specific matrix of a plurality of manpower associated with the digital facility 102.

In an embodiment of the present disclosure, the facility-specific matrix comprises data related to the digital facility 102 which includes but is not limited to the plurality of checkpoints and time to resolve the issue. In addition, the facility-specific matrix includes but is not limited to issue related to the plurality of checkpoints. The facility-specific matrix specific contains details of each micro descriptor of the plurality of micro-descriptors 206a in order to check the status of the digital facility 102.

The plurality of manpower associated with the digital facility 102 is the people involved in maintaining the quality of the digital facility 102. The plurality of manpower includes but is not limited to the one or more staff, the one or more quality managers 206b, and the one or more secret auditors 206c. The one or more staff includes but is not limited to housekeeping staff, kitchen staff, reception staff, serving staff, and security staff.

In an embodiment of the present disclosure, the manpower specific matrix comprises data related to the plurality of manpower of the digital facility 102. The manpower specific matrix includes demographic information of the plurality of manpower, number of task assigned to the plurality of manpower, and the like. The plurality of manpower for manpower specific matrix is the one or more quality managers 206b. In addition, the manpower specific matrix includes a percentage of task completion by the plurality of manpower, number of issues not caught by the plurality of manpower, incentive allocated to the plurality of manpower and the like.

In an embodiment of the present disclosure, the task is the activity which needs to be performed by the plurality of manpower associated with the digital facility 102. The task assigned to the plurality of manpower includes cleaning, auditing rooms, quality checking, checking parking area, checking staff dress and the like. In another embodiment of the present disclosure, the task assigned to the plurality of manpower includes checking the placement of things, checking the quality of food, checking the interior, checking the issue, and the like.

In an embodiment of the present disclosure, the task completion by the plurality of manpower is associated with the total number of the task assigned to the plurality of manpower. Further, the task completion is associated with the total number of the task completed by the plurality of manpower associated with the digital facility 102. The task completion is defined for the one or more quality managers 206b of the plurality of manpower. The task completion defines the performance of the one or more quality managers 206b of the plurality of manpower associated with the digital facility 102.

In an embodiment of the present disclosure, the issue not caught by the plurality of manpower is associated with the one or more issues that is not identified by the one or more quality managers 206b during the audit. The issues not caught are those which are reported by the visitor of the digital facility 102. The number of issues not caught affects the performance of the one or more quality managers 206b of the plurality of manpower based on which incentives are decided.

In an embodiment of the present disclosure, the incentives are allocated to the plurality of manpower associated with the digital facility 102. Incentives are allocated based on the performance of the plurality of manpower associated with the digital facility 102. The incentives are allocated for a specified period of time. The specified period of time includes weekly performance, monthly performance, quarterly performance, yearly performance, daily incentives and the like. The incentives are allocated based on a plurality of factors. The plurality of factors includes but is not limited to percentage of task completion, the number of issues not caught, visitor review 206d, number of high severity issue, number of reoccurrence of the one or more issues and the like.

In an example, the incentives are allocated to the one or more quality managers 206b of the plurality of manpower associated with the digital facility 102 based on the percentage of task completion and the number of issue not caught of the plurality of factors. The incentives are allocated to the one or more staff based on the number of high severity issue, visitor review 206d, and number of reoccurrence of the one or more issues of the plurality of factors.

Moreover, the quality control system 208 maps the facility specific matrix with a pre-defined quality specific matrix wherein mapping being done in real time. The pre-defined quality specific matrix includes but is not limited to the quality of standards that need to be kept in order to maintain the quality of the digital facility 102 to meet visitor satisfaction. The quality specific matrix assists in identifying issues that are below the pre-defined quality standard and to identify deviation from the pre-defined set of data.

Also, the quality control system 208 evaluates a deviation of the mapped data with the quality standards in order to identify the one or more issues associated with the digital facility 102. The evaluation is done in real time. In general, the deviation is the difference by which a quantity differs from a fixed quantity. In context to the present situation, the deviation is the difference observed between the facility specific matrix and the quality specific matrix. The deviation helps to identify the one or more issues that may occur within the digital facility 102. The deviation assists in assigning a degree of severity to the one or more issues. The assignment is done in real time.

In an embodiment of the present disclosure, the degree of severity is the number of values assigned to specify the quality standard of the one or more issues. The high degree of severity means the one or more issues are reaching the time to resolve and the one or more issues have not been resolved. The high degree of severity is assigned to those issues which are having a critical problem and required to be resolved at the earliest. The low level of severity is assigned to one or more issues which are not critical.

In an example, based on the deviation, the one or more issues identified are cracked wall X having time to resolve as 5 days, broken window pane Y having time to resolve as 2-day, broken pipe Z having to resolve as ½ day. The quality control system 208 assigns the degree of severity to the above the one or more issues as broken pipe Z having a high degree of severity, window pane Y having a medium degree of severity and low degree of severity to the cracked wall X.

Also, the quality control system 208 alerts the plurality of manpower associated with the digital facility. The alerts are sent in order to rectify the identified the one or more issues. The rectification is done to maintain the quality of the digital facility 102. The quality control system 208 alters the plurality of manpower in real time. The plurality of manpower includes the one or more quality managers 206b, the one or more secret auditors 206c, and the like. The alerting is done by sending notification to the portable communication device 204.

Also, the quality control system 208 prevents the booking of the plurality of regions of the digital facility 102. The quality control system 208 checks the compliance ratio of the digital facility 102 in real time. If the compliance ratio shows high number of issues open at the region of the plurality of regions of the digital facility 102 with high degree of severity than the identified region is prevented from booking. The prevention is done in real time and each region of the plurality of regions is prevented from booking until the degree of severity, number of issues is reduced to meet the quality standard of the digital facility 102.

The compliance ratio is a metrics which defines the number of issues which are open for resolution and the severity of each issue for each region of the plurality of regions of the digital facility 102. The compliance ratio is being updated in real time based on the number of issue being identified and issue which has been resolved.

In an embodiment of the present disclosure, the quality control system 208 predicts the occurrence of the one or more issues and the time to resolve the one or more issues in order to maintain quality of the digital facility 102. The prevention is done in real time using machine learning algorithm. The prediction is done by analyzing the previously stored data and the data received in real time to identify the one or more issues. The one or more issues that has been predicted by the quality control system 208 is sent as an alert to the plurality of manpower associated with the digital facility 102 in order to rectify the issue before the time to resolve.

In an embodiment of the present disclosure, the quality control system 208 provides incentives to the plurality of manpower associated with the digital facility 102. The incentives are provided based on the analyses of the manpower specific matrix. The incentives are provided to the plurality of manpower with good performance record. Incentives are provided based on the performance of the plurality of manpower associated with the digital facility 102. The incentives are decided for a specified period of time. The specified period of time includes weekly performance, monthly performance, quarterly performance, yearly performance, daily incentives and the like. The incentives are appraised on the number of task completion, the number of issues not caught, the rating given by the visitor and the like.

The quality control system 208 is associated with the server 212 through the communication network 210. In an embodiment of the present disclosure, the communication network 210 enables the quality control system 208 to gain access to the internet for transmitting data to the server 212. Moreover, the communication network 210 provides a medium to transfer the data between the quality control system 208 and the server 212. Further, the medium for communication may be internet, infrared, microwave, radio frequency (RF) and the like.

In an embodiment of the present disclosure, the quality control system 208 is located in the server 212. In another embodiment of the present disclosure, the quality control system 208 is located in the portable communication device 204. The server 212 handles each operation and task performed by the quality control system 208. The server 212 stores one or more instructions for performing the various operations of the quality control system 208.

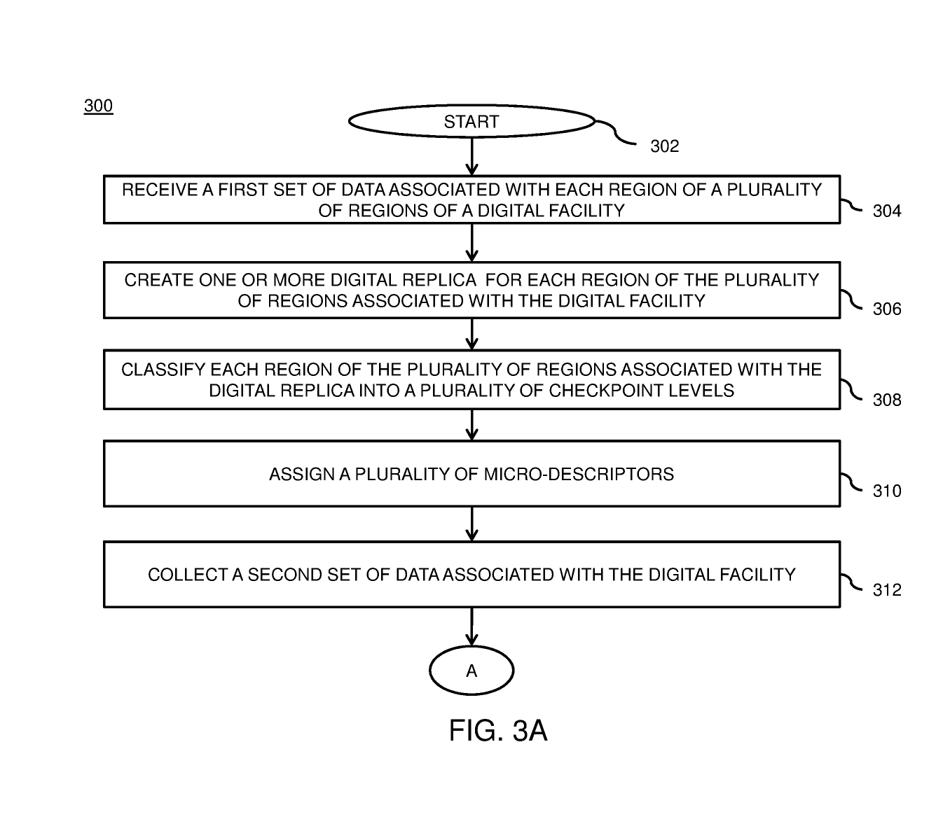

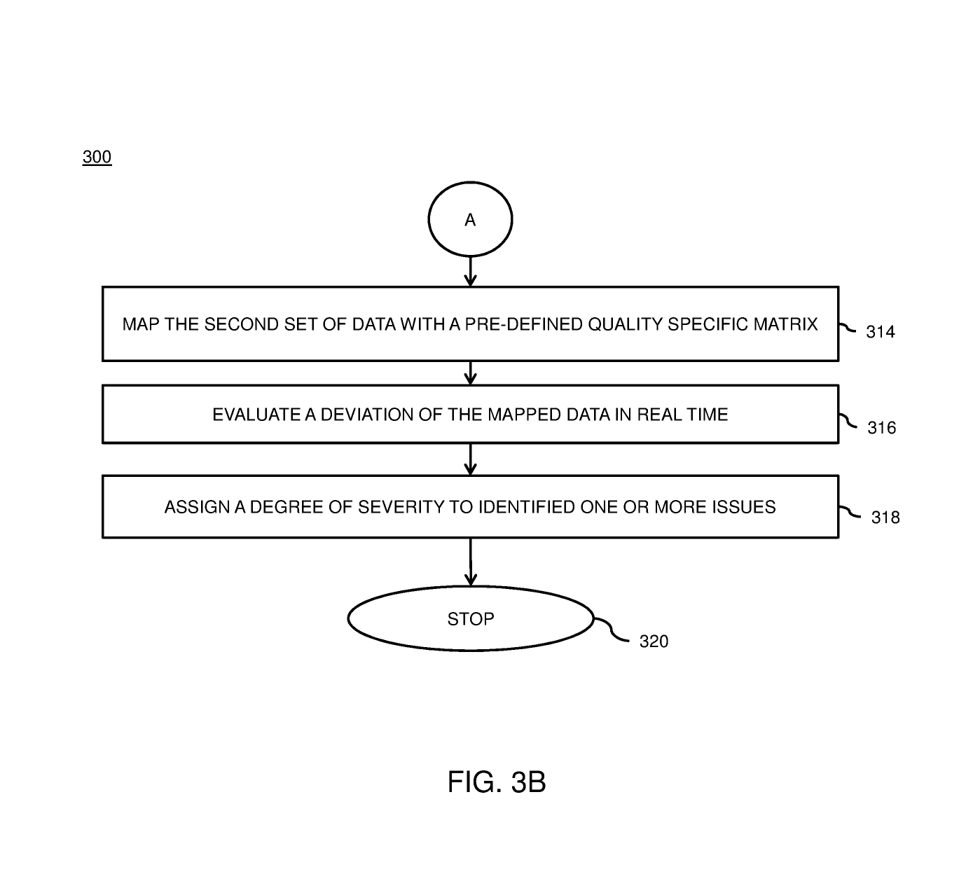

FIG. 3A and FIG. 3B illustrate a flowchart 300 for a method for quality control of a digital facility based on feedback from a plurality of sources, in accordance with various embodiments of the present disclosure. It may be noted that to explain the process steps of the flowchart 300, references will be made to the system elements of FIG. 1A, FIG. 1B, FIG. 1C and FIG. 2. It may be noted that the flowchart 300 may have lesser or more number of steps.

The flowchart 300 initiates at step 302. Following step 302, at step 304, the quality control system 208 receives the first set of data in real time. The first set of data is associated with each region of the plurality of regions of the digital facility 102. The first set of data is received from the plurality of data sources 202. At step 306, the quality control system 208 creates the one or more digital replica for each region of the plurality of regions of the digital facility 102 by using the first set of data in real time. At step 308, the quality control system 208 classifies each region of the plurality of regions associated with the digital facility 102 into a plurality of checkpoints levels. The plurality of checkpoints levels is used to simplify the distribution of each area of the plurality of areas of the digital facility 102. At step 310, the quality control system 208 assigns the plurality of micro-descriptors 206a which facilitates to provide feedback of each region of the plurality of regions of the digital facility 102. The plurality of micro-descriptors 206a is assigned to the lowest level of the plurality of checkpoint levels of the digital facility 102. The feedback is collected for the plurality of micro-descriptors 206a. At step 312, the quality control system 208 collects a second set of data associated with the digital facility 102 in real time. The second set of data is collected from the plurality of sources 206 for the plurality of micro-descriptors 206a. At step 314, the quality control system 208 maps the facility specific matrix with a pre-defined quality specific matrix wherein mapping being done in real time. The pre-defined quality specific matrix includes but may not be limited to the quality of standards that need to be kept in order to maintain the quality of the digital facility 102 to meet visitor satisfaction. At step 316, the quality control system 208 evaluates a deviation of the mapped data with the quality standards in order to identify the one or more issues associated with the digital facility 102. At step 318, the quality control system 208 assigns the degree of severity to the identified one or more issues. The flow chart 300 terminates at step 320.

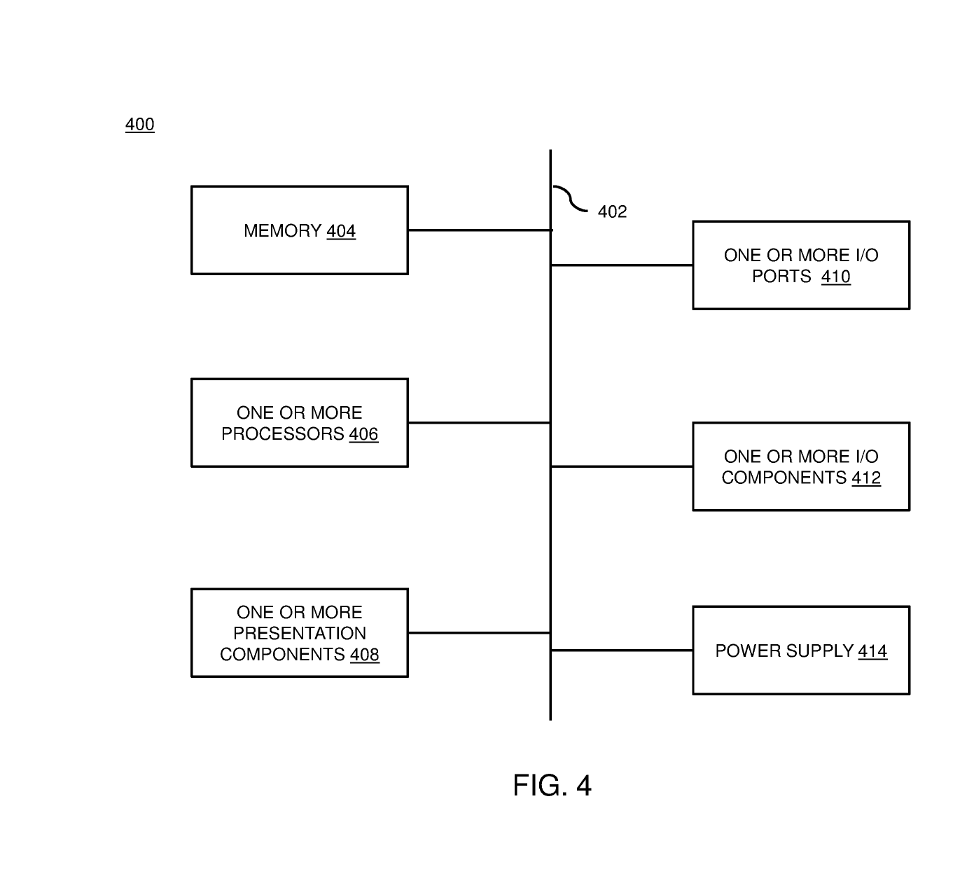

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 4 is merely illustrative of an exemplary computing device 400 may be used in connection with one or more embodiments of the present disclosure. Distinction is not made between such categories as workstation, server, laptop, hand-held device and the like, as all are contemplated within the scope of FIG. 4 and reference to “the computing device 400.”

The computing device 400 typically includes a computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 404 includes the computer-storage media in the form of volatile and/or nonvolatile memory. The memory 404 may be removable, non-removable, or a combination thereof. Exemplary hardware devices include solid-state memory, hard drives, optical-disc drives and the like. The computing device 400 includes the one or more processors to read data from various entities such as memory 404 or I/O components 412. The one or more presentation components 408 present data indications to a user or other device. Exemplary presentation components include a display device, speaker, printing component, vibrating component and the like. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device and the like.

What is claimed is:

1. A computer-implemented method for quality control of a digital facility based on feedback from a plurality of sources, the computer-implemented method comprising:
receiving, at a quality control system with a processor, a first set of data associated with each region of a plurality of regions of the digital facility, wherein the first set of data being received from a plurality of data sources, wherein the first set of data being received in real time;
creating, at the quality control system with the processor, one or more digital replica for each region of the plurality of regions associated with the digital facility, wherein the one or more digital replica being created with the facilitation of the first set of data;
classifying, at the quality control system with the processor, each region of the plurality of regions associated with a digital replica into a plurality of checkpoint levels, wherein the plurality of checkpoint levels being classified based on a pre-defined set of data;
assigning, at the quality control system with the processor, a plurality of micro-descriptors, wherein the plurality of micro-descriptors being assigned to lowest level of the plurality of checkpoint levels, wherein the plurality of micro-descriptors facilitates to provide feedback of each region of the plurality of regions of the digital facility;
collecting, at the quality control system with the processor, a second set of data associated with the digital facility, wherein the second set of data being collected from the plurality of sources for the plurality of micro-descriptors, wherein the second set of data comprises:
a facility-specific matrix of the digital facility, wherein the facility-specific matrix contains a plurality of quality specific data, wherein the facility-specific matrix being collected in real time;
a manpower specific matrix of a plurality of manpower associated with the digital facility, wherein the manpower specific matrix contains a set of data of each of the plurality of manpower associated with the digital facility, wherein the manpower specific matrix being collected in real time;
mapping, at the quality control system with the processor, the second set of data with a pre-defined quality specific matrix, wherein the mapping being done in real time;
evaluating, at the quality control system with the processor, a deviation of the mapped data in real time, wherein the evaluation being done to identify one or more issues associated with the digital facility; and
assigning, at the quality control system with the processor, a degree of severity to the identified one or more issues, wherein the assigning being done to identify one or more high severity issues, wherein the one or more high severity issues being identified for rectification.

2. The computer-implemented method as recited in claim 1, wherein the plurality of data sources comprises a facility manager, a digital camera, a digital blueprint, a communication device, and one or more graphical sensors.

3. The computer-implemented method as recited in claim 1, wherein the plurality of sources comprises the plurality of micro-descriptors, one or more quality managers, one or more secret auditors, visitor review, call center review and a plurality of feedback sensors.

4. The computer-implemented method as recited in claim 1, wherein the one or more issues comprises fault in electrical appliance, unprofessional manpower, unprofessional quality manager, hygiene, cleanliness, security, limited amenities at the digital facility, wireless connectivity issues, noise, pollution and lack of manpower at the digital facility.

5. The computer-implemented method as recited in claim 1, further comprising updating, at the quality control system with the processor, the first set of data, the second set of data, the one or more issues and the degree of severity, wherein the updating being done in real time.

6. The computer-implemented method as recited in claim 1, further comprising storing, at the quality control system with the processor, the first set of data, the second set of data, the one or more issues and the degree of severity, wherein the storing being done in real time.

7. The computer-implemented method as recited in claim 1, further comprising allocating, at the quality control system with the processor, incentives to the plurality of manpower associated with the digital facility based on a plurality of factors.

8. The computer-implemented method as recited in claim 1, further comprising preventing, at the quality control system with the processor, booking of each region of the plurality of regions of the digital facility, wherein the prevention being done with the facilitation of a compliance ratio of the digital facility, wherein the preventing being done in real time.

9. The computer-implemented method as recited in claim 1, further comprising predicting, at the quality control system with the processor, the one or more issues and time to resolve the one or more issues in order to maintain the quality of the digital facility, wherein the prediction being done based on the previously stored data and real-time data.

10. The computer-implemented method as recited in claim 1, further comprising alerting, at the quality control system with the processor, the plurality of manpower associated with the digital facility to rectify the one or more issues prior to the time to resolve, wherein the alerting being done in order to maintain a quality of the plurality of regions of the digital facility, wherein the quality control system alerts an auditor to audit the plurality of regions of the digital facility.

11. A computer system comprising:
one or more processor; and
a memory coupled to the one or more processors, the memory for storing instructions which, when executed by the one or more processors, cause the one or more processors to perform a method for quality control of a digital facility based on feedback from a plurality of sources, the method comprising:
receiving, at a quality control system, a first set of data associated with each region of a plurality of regions of the digital facility, wherein the first set of data being received from a plurality of data sources, wherein the first set of data being received in real time;
creating, at the quality control system, one or more digital replica for each region of the plurality of regions associated with the digital facility, wherein the one or more digital replica being created with the facilitation of the first set of data;
classifying, at the quality control system, each region of the plurality of regions associated with a digital replica into a plurality of checkpoint levels, wherein the plurality of checkpoint levels being classified based on a pre-defined set of data;
assigning, at the quality control system, a plurality of micro-descriptors, wherein the plurality of micro-descriptors being assigned to lowest level of the plurality of checkpoint levels, wherein the plurality of micro-descriptors facilitates to provide feedback of each region of the plurality of regions of the digital facility;
collecting, at the quality control system, a second set of data associated with the digital facility, wherein the second set of data being collected from the plurality of sources for the plurality of micro-descriptors, wherein the second set of data comprises:
a facility-specific matrix of the digital facility, wherein the facility-specific matrix contains a plurality of quality specific data, wherein the facility-specific matrix being collected in real time;
a manpower specific matrix of a plurality of manpower associated with the digital facility, wherein the manpower specific matrix contains a set of data of each of the plurality of manpower associated with the digital facility, wherein the manpower specific matrix being collected in real time;
mapping, at the quality control system, the second set of data with a pre-defined quality specific matrix, wherein the mapping being done in real time;
evaluating, at the quality control system, a deviation of the mapped data in real time, wherein the evaluation being done to identify one or more issues associated with the digital facility; and
assigning, at the quality control system, a degree of severity to the identified one or more issues, wherein the assigning being done to identify one or more high severity issues, wherein the one or more high severity issues being identified for rectification.

12. The computer system as recited in claim 11, wherein the plurality of data sources comprises a facility manager, a digital camera, a digital blueprint, a communication device, and one or more graphical sensors.

13. The computer system as recited in claim 11, wherein the plurality of sources comprises the plurality of micro-descriptors, one or more quality managers, one or more secret auditors, visitor review, call center review and a plurality of feedback sensors.

14. The computer system as recited in claim 11, wherein the one or more issues comprises fault in electrical appliance, unprofessional manpower, unprofessional quality manager, hygiene, cleanliness, security, limited amenities at the digital facility, wireless connectivity issues, noise, pollution and lack of manpower at the digital facility.

15. The computer system as recited in claim 11, further comprising storing, at the quality control system, the first set of data, the second set of data, the one or more issues and the degree of severity, wherein the storing being done in real time.

16. The computer system as recited in claim 11, further comprising allocating, at the quality control system, incentives to the plurality of manpower associated with the digital facility based on a plurality of factors.

17. The computer system as recited in claim 11, further comprising preventing, at the quality control system, booking of each region of the plurality of regions of the digital facility, wherein the prevention being done with the facilitation of a compliance ratio of the digital facility, wherein the preventing being done in real time.

18. The computer system as recited in claim 11, further comprising predicting, at the quality control system, the one or more issues and time to resolve the one or more issues in order to maintain the quality of the digital facility, wherein the prediction being done based on the previously stored data and real-time data.

19. The computer system as recited in claim 11, further comprising alerting, at the quality control system, the plurality of manpower associated with the digital facility to rectify the one or more issues prior to the time to resolve, wherein the alerting being done in order to maintain a quality of the plurality of regions of the digital facility, wherein the quality control system alerts an auditor to audit the plurality of regions of the digital facility.

20. A computer-readable storage medium encoding computer executable instructions that, when executed by at least one processor, performs a method for quality control of a digital facility based on feedback from a plurality of sources, the method comprising:
receiving, at a computing device, a first set of data associated with each region of a plurality of regions of the digital facility, wherein the first set of data being received from a plurality of data sources, wherein the first set of data being received in real time;
creating, at the computing device, one or more digital replica for each region of the plurality of regions associated with the digital facility, wherein the one or more digital replica being created with the facilitation of the first set of data;
classifying, at the computing device, each region of the plurality of regions associated with a digital replica into a plurality of checkpoint levels, wherein the plurality of checkpoint levels being classified based on a pre-defined set of data;
assigning, at the computing device, a plurality of micro-descriptors, wherein the plurality of micro-descriptors being assigned to lowest level of the plurality of checkpoint levels, wherein the plurality of micro-descriptors facilitates to provide feedback of each region of the plurality of regions of the digital facility;
collecting, at the computing device, a second set of data associated with the digital facility, wherein the second set of data being collected from the plurality of sources for the plurality of micro-descriptors, wherein the second set of data comprises:
a facility-specific matrix of the digital facility, wherein the facility-specific matrix contains a plurality of quality specific data, wherein the facility-specific matrix being collected in real time;
a manpower specific matrix of a plurality of manpower associated with the digital facility, wherein the manpower specific matrix contains a set of data of each of the plurality of manpower associated with the digital facility, wherein the manpower specific matrix being collected in real time;
mapping, at the computing device, the second set of data with a pre-defined quality specific matrix, wherein the mapping being done in real time;
evaluating, at the computing device, a deviation of the mapped data in real time, wherein the evaluation being done to identify one or more issues associated with the digital facility; and
assigning, at the computing device, a degree of severity to the identified one or more issues, wherein the assigning being done to identify one or more high severity issues, wherein the one or more high severity issues being identified for rectification.
